(19) United States
(12) Patent Application Publication
(10) Pub. No.: US 2009/0146948 A1
(43) Pub. Date: Jun. 11, 2009

(54) Apparatus for Providing Sensing Information

(75) Inventors: Jun Young Lee, Daejeon (KR); Ki Uk Kyung, Daejeon (KR); Hee Sook Shin, Daejeon (KR); Jun Seok Park, Daejeon (KR); Dong Won Han, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTIT, Daejeon (KR)

(21) Appl. No.: 12/084,692

(22) PCT Filed: Jan. 23, 2007
(86) PCT No.: PCT/KR2007/000396

§ 371 Date: May 8, 2008

(30) Foreign Application Priority Data
Sep. 29, 2006 (KR) 10-2006-0096561

(51) Int. Cl. G09G 5/00

(52) U.S. Cl. 345/156

(57) ABSTRACT

The invention relates to an apparatus for providing sensing information which includes a surface-sensing information combiner for collecting tactile sensing information on a surface of an object and accompanying sensing information attendant on the tactile sensing information of the surface of the object to produce surface-sensing information or edit the produced surface-sensing information. The apparatus also includes a surface-sensing information board for providing an environment for the surface-sensing information of the object to allow a user to perceive the surface-sensing information of the object. The apparatus further includes a surface-sensing information reproducer for reproducing the tactile sensing information and the accompanying sensing information of the object to be sensed by the user.

This application claims the benefit under 35 U.S.C. Section 371, of PCT International Application Number PCT/KR2007/000396, filed Jan. 23, 2007, which claimed priority to Korean Application No. 10-2006-0096561, filed Sep. 29, 2006 in Republic of Korea, the contents of all of which are incorporated herein by reference.

### TECHNICAL FIELD

The present invention relates to an apparatus for providing sensing information, and more particularly, to an apparatus for providing sensing information on a surface of an object in order to more effectively express and share surface-sensing information necessary for a user to perceive the surface of the object.

### BACKGROUND ART

In conventional computer technology, visual information is mainly used in transmitting and receiving information between a human and a computer. However, as the user desires more specific and realistic information via virtual reality, haptic technology has been developed to convey tactile sensation and force.

Through a haptic device, which has been invented for interaction between a human and a virtual environment, the human gives a command to the virtual environment and in turn feels the tactile sensation and force conveyed from the virtual environment. In order to provide a simulator adopting the haptic technology, a haptic device, haptic rendering and computer graphics technology are required.

Although researches have been conducted on providing services from a remote place at real time using such devices for expressing human sensations, these devices have been limited to conveying force sensation to date.

To overcome such limitations, researches have been continued on expressing tactile sensation, and succeeded in developing new kinds of apparatuses for reproducing tactile sensation. To date, however, the expression of tactile sensation has been limited to combining visual and auditory elements with the tactile sensation.

### DISCLOSURE OF INVENTION

### Technical Problem

The present invention has been made to solve the foregoing problems of the prior art and therefore an object of certain embodiments of the present invention is to provide an apparatus which analyzes interaction information among sensations of a human affecting perception through tactile sensation and integrates the analyzed information into sensation information needed for perceiving a surface of the object, thereby more effectively expressing and sharing surface sensation of the object, and a method therefor.

Another object of certain embodiments of the present invention is to provide an apparatus which can effectively edit, provide and share sensation information needed for perceiving a surface of the object, and a method therefor.

### Technical Solution

According to an aspect of the invention for realizing the object, there is provided an apparatus for providing sensing information. The apparatus includes a surface-sensing information combiner for collecting tactile sensing information on a surface of an object and accompanying sensing information attendant on the tactile sensing information of the surface of the object to produce surface-sensing information and edit the produced surface-sensing information; a surface-sensing information board for providing an environment for the surface-sensing information of the object to allow a user to perceive the surface-sensing information of the object; and a surface-sensing information reproducer for reproducing the tactile sensing information and the accompanying sensing information of the object to be sensed by the user.

Preferably, the surface-sensing information board includes a background-providing device for providing an environment where the tactile sensing information and the accompanying sensing information attendant upon the tactile sensing information of the surface of the object, reproduced by the surface-sensing information reproducing device, interact with each other; and an image map managing part for storing and managing a surface sensation image map.

Preferably, the apparatus may further include a surface-sensing information sharer for executing procedures necessary for sharing the reproduced surface-sensing information with a counterpart.

### BRIEF DESCRIPTION OF THE DRAWINGS

FIG. 1 is a schematic view illustrating an apparatus for providing sensing information according to an embodiment of the present invention;

FIG. 2 is a schematic view illustrating a surface-sensing information reproducer of the apparatus for providing sensing information according to the present invention;

FIG. 3 is a schematic view illustrating a surface-sensing information combiner of the apparatus for providing sensing information according to the present invention;

FIG. 4 is a schematic view illustrating a surface-sensation scanner of the apparatus for providing sensing information according to the present invention;

FIG. 5 is a schematic view illustrating operation of a surface-sensation image map according to the present invention;

FIG. 6 is a flow chart illustrating a method of providing surface-sensing information using the apparatus for providing sensing information according to an embodiment of the present invention; and

FIG. 7 is a flow chart illustrating the method of providing surface-sensing information using the apparatus for providing sensing information according to the embodiment of the present invention.

### MODE FOR THE INVENTION

Preferred embodiments of the present invention will now be described in detail with reference to the accompanying drawings. In the following description, well-known functions and constructions are not described in detail since they would obscure the intention in unnecessary detail.

In addition, the same reference numerals are used throughout the drawings to designate the same or similar components.

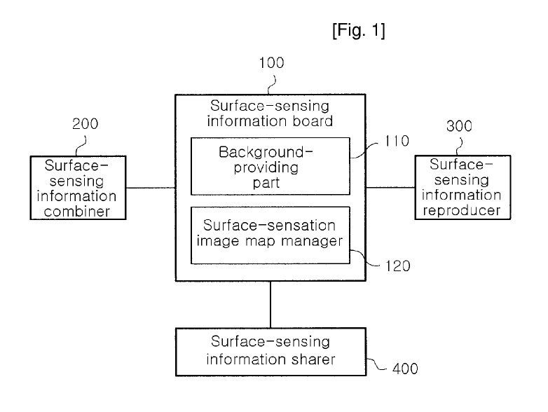

FIG. 1 illustrates a configuration of an apparatus for providing sensing information according to an embodiment of the present invention. Other components may also be included in addition to the components to be described hereunder but FIG. 1 illustrates only the necessary components for the sake of convenience in explanation.

Referring to FIG. 1, the apparatus for providing sensing information includes a surface-sensing information combiner 200, a surface-sensing information board 100, a surface-sensing information sharer 400 and a surface-sensing information reproducer 300. The surface-sensing information board 100 includes a background-providing part 110 and a surface-sensation image map manager 120.

The surface-sensing information combiner 200 collects tactile sensing information on a surface of an object and accompanying sensing information attendant on the tactile sensing information on the surface of the object to produce surface-sensing information or edit the produced surface-sensing information. Here, it is preferable that the accompanying sensing information is at least one selected from a group consisting of visual, auditory, taste and olfactory sensing information attendant on the tactile sensing information obtained from touching the surface of the object. For example, in a case of a peach as the object, sensations such as cold feeling, soft feeling or squashy feeling are the tactile sensing information of the surface of the object. Here, the sound of rubbing or pressing the peach belongs to the auditory sensing information on the surface of the object while the smell from rubbing the peach belongs to the olfactory sensing information on the surface of the object. In addition, exterior features such as protrusions and wrinkles of the surface affecting the tactile sensation of rubbing the surface of the peach belong to the visual sensing information on the surface of the object, and the sweet taste of the peach belongs to the taste sensing information.

The surface-sensing information board 100 provides an overall environment allowing the user to perceive the surface-sensing information of the object according to the present invention. According to an embodiment of the present invention, it is preferable that the surface-sensing information board 100 includes the background-providing part 110 and the surface-sensation image map manager 120 to more effectively express the surface-sensing information on the surface of the object.

The background-providing part 110 provides a basic environment or a surface-sensation background in which the tactile sensing information and the accompanying sensing information attendant on the tactile sensing information, reproduced by the surface-sensation information reproducer 300 can interact with each other. In addition, the surface-sensation image map manager 120 stores and manages a surface-sensation image map generated or edited by the surface-sensing information combiner 200 or transmitted from an apparatus for providing sensing information of a counterpart via the surface-sensing information sharer 400.

At this time, the surface-sensation background provides only a basic environment allowing the user to perceive the surface-sensing information on the object, and the surface-sensation image map provides additional environment. That is, in the surface-sensing information board 100 for providing the environment allowing the user to feel the tactile sensation, the surface-sensation background serves to furnish an overall environment whereas the surface-sensation image map is where regional tactile sensing information locally added by the user is edited.

For example, in a case of a scented wall paper as the object which partially has embossed patterns, the basic patterns and the scent across the wall paper are provided as the surface-sensing information of the surface-sensation image map, whereas the tactile sensing information perceived by the user rubbing the partial embossed patterns is the additional information of the surface-sensation image map. That is, the surface-sensation background provides only the surrounding environment which allows the user to have more realistic feeling of the surface-sensation information of the wall paper, whereas the surface-sensation image map provides the accompanying sensing information obtained from interacting with the object such as rubbing the object with hands.

At this time, the basic unit for recording the surface-sensing information in the image map provided by the surface-sensation image map manager 120 is a surface-sensing unit.

The surface-sensing information reproducer 300 reproduces the tactile and accompanying sensing information of the object to be sensed by the user. The surface-sensing information reproducer 300 retrieves the image map corresponding to the object, stored in the surface-sensation image map manager 120, and reproduces the surface-sensing information on the object.

The surface-sensing information sharer 400 executes procedures necessary for sharing the sensing information of the object with a counterpart. In order for this, the surface-sensing information sharer 400 transmits or receives the image map which includes the surface-sensing information of the object. At this time, if changes occur only for some surface-sensing units of the image map already stored, the surface-sensing information sharer 400 may also exchange partial information corresponding only to those surface-sensing units.

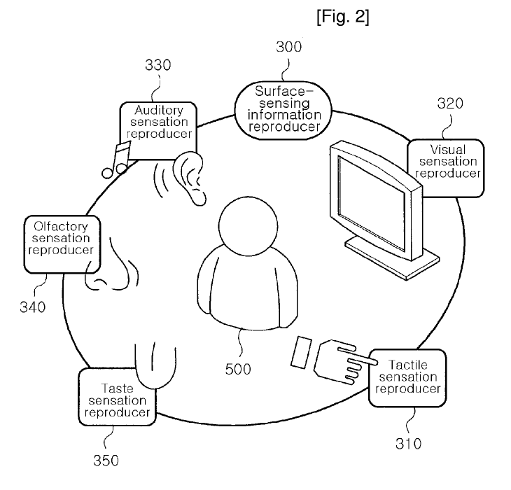

Now, the apparatus for providing sensing information shown in FIG. 1 will be explained in greater detail with reference to FIGS. 2 to 5.

FIG. 2 is a view illustrating a schematic configuration of the surface-sensing information reproducer 300 of the apparatus for providing sensing information according to the present invention. Referring to FIG. 2, the surface-sensing information reproducer 300 according to the present invention may include a tactile sensation reproducer 310, a visual sensation reproducer 320, an auditory sensation reproducer 330, an olfactory sensation reproducer 340 and a taste sensation reproducer 350. The surface-sensing information reproducer 300 may be configured to include at least one from a group consisting of the above reproducers, located in positions that allow the user 500 to perceive the respective sensations.

The tactile sensation reproducer 310 reproduces the tactile sensation felt through the skin when touching the surface of the object. Such a tactile sensation reproducer 310 physically transmits stimulation such as force and texture to the body parts capable of perceiving the tactile stimulation such as the hands or skin of the user so that the user perceives such stimulation. It is preferable that the tactile sensation reproducer 310 applicable to the present invention is capable of expressing shape, hardness, curvature, roughness, lattice, embossed patterns, surface temperature, etc. of the object.

The visual sensation reproducer 320 shows a visual image appropriate for expressing the texture of the surface of the object to enhance the realistic feeling of the texture of the surface to be reproduced. Such a visual image can be reproduced through a display device such as a computer monitor.

The auditory sensation reproducer 330 reproduces the sound of touching the surface of the object to enhance the realistic feeling of the tactile sensation of the surface of the object. Preferably, the examples of the auditory sensation reproducer 330 include a speaker or ear phones.

The olfactory sensation reproducer 340 provides scent information related to the surface of the object to enhance the realistic feeling of the tactile sensation of the surface of the object to be conveyed. Preferably, the examples of the olfactory sensation reproducer 340 include a scent-emitting device which stores and combines various types of scent information to spray the particular one of the scent information.

The taste sensation reproducer 350 provides particular taste information related to the surface of the object to enhance the realistic feeling of the tactile sensation of the surface of the object to be conveyed. Such a taste sensation reproducer 350 is more effective when the tactile sensation of the surface of the object is closely related to taste.

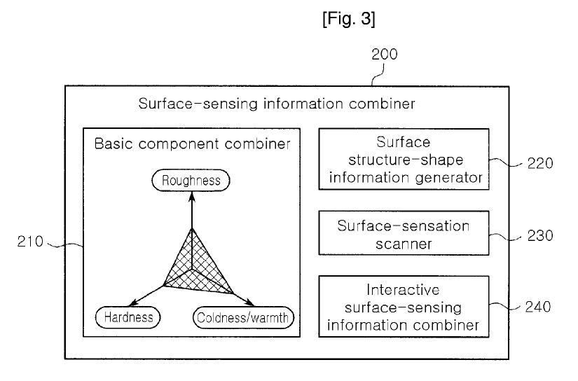

FIG. 3 is a view illustrating a schematic configuration of the surface-sensing information combiner 200 of the apparatus for providing sensing information according to the present invention. Referring to FIG. 3, the surface-sensing information combiner 200 includes a basic-component combiner 210, a surface structure-shape information generator 220, a surface-sensation scanner 230 and an interactive sensing information combiner 240.

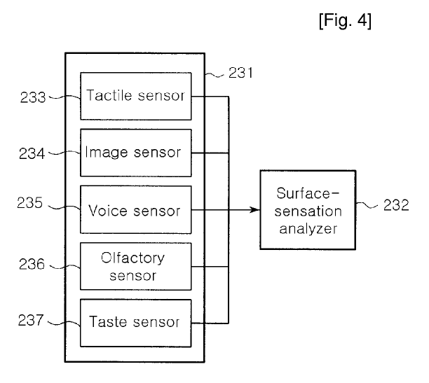

The surface-sensation scanner 230 collects the tactile sensing information on the surface of the object and the accompanying sensing information attendant on the tactile sensing information on the surface of the object. The surface-sensation scanner will be explained later in greater detail with reference to FIG. 4.

The basic-component combiner 210 combines information on the texture, hardness, coldness/warmth of the surface of the object collected from the surface-sensation scanner 230. The pieces of information on texture, hardness, coldness/warmth are basic components of sensing information serving as a reference for the user in perceiving the surface of the object through tactile sensation. Therefore, when changes occur in the above basic components of the object, the user sensitively feels the changes in the tactile sensation while tactually feeling the object.

The surface structure-shape information generator 220 generates information corresponding to the surface structure and shape, such as the patterns or curvature of the surface, based on the information collected by the surface-sensation scanner 230.

The interactive surface-sensing information combiner 240 combines the information collected by the surface-sensation scanner 230, together with the information on interaction among the sensations, to produce surface-sensing information.

FIG. 4 is a view illustrating a schematic configuration of the surface-sensation scanner of the apparatus for providing sensing information according to the present invention. Referring to FIG. 4, the surface-sensation scanner mainly includes a sensor 231 and a surface-sensation analyzer 232.

The sensor 231 includes a tactile sensor 233, an image sensor 234, a voice sensor 235, an olfactory sensor 236 and a taste sensor 237. The tactile sensor 233 measures the texture, hardness, temperature, specific heat, etc., and the image sensor obtains an image of a part of the object touched by the user. The voice sensor 235 measures the sound such as the friction sound from touching the object by the user, the olfactory sensor 236 measures the smell from the object, and the taste sensor 237 measures the taste of the object.

The surface-sensation analyzer 232 integrates and classifies the sensations received by the sensor 231 to analyze interaction among the sensations, necessary for perceiving the surface of the object.

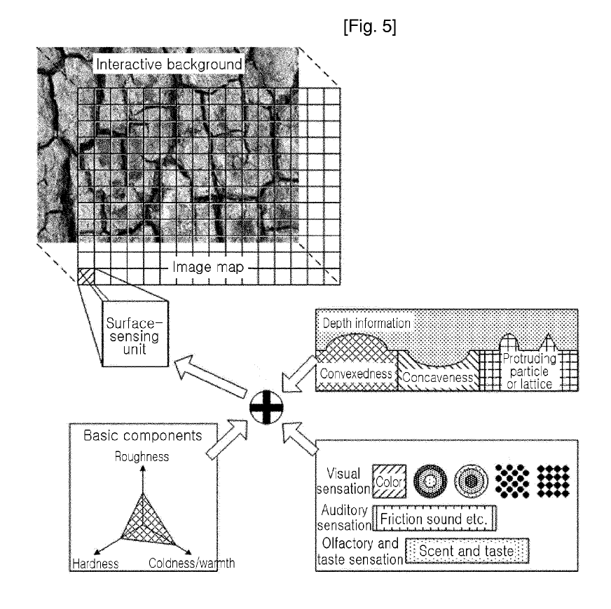

FIG. 5 is a view illustrating the operation of the surface-sensation image map according to the present invention in detail.

Referring to FIG. 5, the surface-sensation image map is formed corresponding to the surface-sensation background provided by the background-providing part. Here, the surface-sensation background provides a basic environment allowing the user to perceive the surface-sensing information of the object. The surface-sensing information of the object is recorded in the image map by the surface-sensing units. In particular, information on the combination of the basic components, the surface structure and shape and surface-sensing information corresponding to the surface-sensing units of the object are recorded.

According to a certain embodiment of the present invention, the information on combination of the basic components consists of basic tactile elements such as texture, hardness and coldness/warmth of the surface of the object. In addition, the information on the surface shape and structure is translated into two-dimensional depth information and included in the information corresponding to the surface-sensing unit. In addition, the information on the interaction of the sensations entails combination of additional sensing information including the visual element such as color, convexedness, concaveness, protruding particles or sharp protruding particles, patterns, etc., the auditory element such as friction sound and the olfactory and taste elements such as scent and taste from the object.

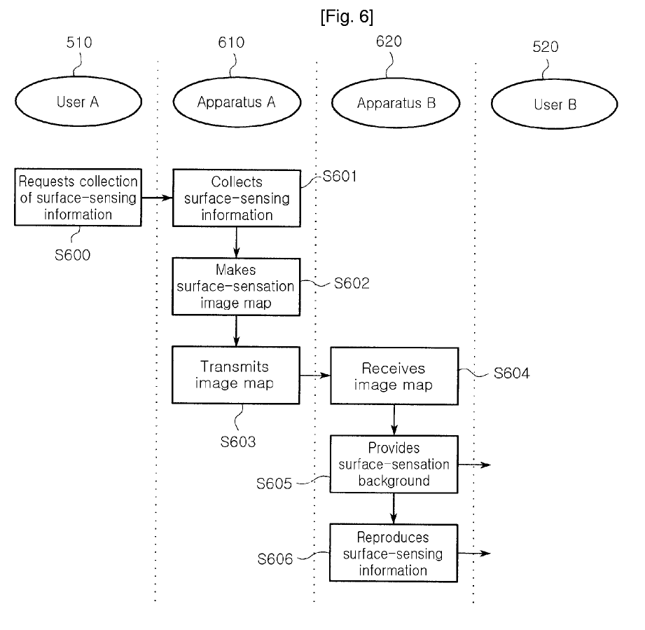

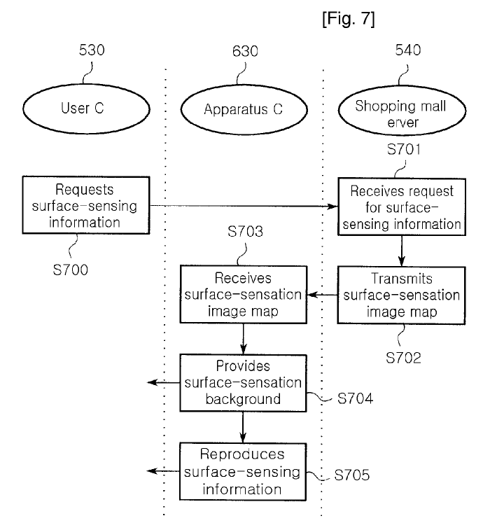

FIGS. 6 and 7 are flow charts illustrating the methods of providing surface-sensing information using the apparatus for providing sensing information according to the present invention.

Referring to FIG. 6, while user A, 510 (hereinafter referred to as ‘user A’) and user B, 520 (hereinafter referred to as ‘user B’) are having a conversation via an instant messenger on the Internet, user A wants to convey surface sensation of a peach he/she has, to user B. At this time, user A and user B have an apparatus A, 610 for providing sensing information (hereinafter, referred to as ‘apparatus A’) and an apparatus B, 620 for providing sensing information (hereinafter, referred to as apparatus B’), respectively. Preferably, a Plug-In of the messenger service may be provided as each of the surface-sensing information providing board of the apparatuses for providing sensing information.

First, if the peach is determined as the object user A wants to convey to user B, user A requests his/her apparatus A to collect information related to surface sensation of the peach in S600. After receiving the request, the apparatus A collects the surface-sensing information on the peach possessed by user A using the surface-sensing information combiner (not shown) provided therein in S601.

At this time, apparatus A collects cold, soft and squashy feeling from rubbing the surface of the peach as the tactile sensing information, the sound from rubbing or pressing the surface of the peach as the auditory sensing information on the surface of the object, the smell from each time rubbing the peach as the olfactory sensing information on the surface of the object, the color and texture of the surface of the peach as the visual sensing information and the sweet taste of the peach as the taste sensing information.

The surface-sensing information collected as above is converted into a surface-sensation image map to be stored in S602, and transmitted to apparatus B of user B in S603.

When apparatus B of user B receives the image map of the surface-sensing information of the peach in S604, first, it provides information on the surface sensation background of the peach itself to user B in S605. In order for this, apparatus B registers the exterior image of the peach to the surface-sensing information board 100 (not shown).

Next in S606, based on the surface-sensation image map received as above, apparatus B provides the surface-sensing information of the peach in a form perceivable by user B.

Referring to FIG. 7, user C, 530 (hereinafter referred to as ‘user C’) wants to purchase a wall paper at a shopping mall server 540. Preferably, the shopping mall server 540 may provide a Flash Board for the surface-sensing information providing board of the apparatus for providing sensing information according to the present invention.

First, user C selects a wall paper desired to purchase and requests the shopping mall server 540 to provide surface-sensing information on the wall paper in S700.

After the shopping mall server 540 receives the request in S701, it provides the image map information on the surface of the wall paper to the apparatus C, 630 for providing sensing information (hereinafter, referred to as ‘apparatus C’) of user C in order to share the surface sensation of the wall paper with user C in S702.

When apparatus C receives the image map information from the shopping mall server 540 in S703, it provides information on the surface sensation background of the wall paper itself to user C in S704. In order for this, apparatus C registers the exterior image of the wall paper to the surface-sensing information board 100 (not shown) of user C.

Next in S705, apparatus C provides the surface-sensing information in a form perceivable by user C based on the surface-sensation image map of the wall paper received as above.

According to the present invention, interaction information on sensations affecting tactile perception of an object is analyzed and included in sensing information necessary for perceiving a surface of the object, which allows more effectively expressing and sharing surface sensation of the object. Further, the sensing information necessary for perceiving the surface of the object is effectively edited, provided and shared according to the present invention.

While the present invention has been shown and described in connection with the preferred embodiments, it will be apparent to those skilled in the art that modifications and variations can be made without departing from the spirit and scope of the invention as defined by the appended claims.

1. An apparatus for providing sensing information comprising:
a surface-sensing information combiner for collecting tactile sensing information on a surface of an object and accompanying sensing information attendant on the tactile sensing information of the surface of the object to produce surface-sensing information or edit the produced surface-sensing information;
a surface-sensing information board for providing an environment for the surface-sensing information of the object to allow a user to perceive the surface-sensing information of the object; and
a surface-sensing information reproducer for reproducing the tactile sensing information and the accompanying sensing information of the object to be sensed by the user.

2. The apparatus according to claim 1, wherein the surface-sensing information board comprises:
a background-providing device for providing an environment where the tactile sensing information and the accompanying sensing information attendant upon the tactile sensing information of the surface of the object, reproduced by the surface-sensing information reproducing device, interact with each other; and
an image map managing part for storing and managing a surface sensation image map.

3. The apparatus according to claim 1, further comprising a surface-sensing information sharer for executing procedures necessary for sharing the reproduced surface-sensing information with a counterpart.

4. The apparatus according to claim 1, wherein the accompanying sensing information comprises at least one selected from a group consisting of visual, auditory, taste and olfactory sensation information attendant on the tactile sensing information obtained from contacting the surface of the object.

5. The apparatus according to claim 2, wherein the surface-sensing information reproducer is adapted to reproduce the surface-sensing information based on the surface-sensation image map stored in the image map managing unit.

6. The apparatus according to claim 1, wherein the surface-sensing information reproducer comprises at least one selected from a group consisting of a tactile sensation reproducer, a visual sensation reproducer, an auditory sensation reproducer, an olfactory sensation reproducer and a taste sensation reproducer.

7. The apparatus according to claim 1, wherein the surface-sensing information combiner comprises:
a surface-sensation scanner for collecting the tactile sensing information and the accompanying sensing information attendant on the tactile sensing information on the surface of the object;
a basic-component combiner for combining information on roughness, hardness and coldness/warmth from the surface of the object, collected by the surface-sensation scanner;
a surface structure-shape information generator for generating information on the structure and shape of the surface of the object such as surface patterns or curvature based on the information collected by the surface-sensation scanning part; and
an interactive surface-sensing information combiner for combining the sensing information collected by the surface-sensation scanner and adding information on interaction among the sensing information to produce the surface-sensing information.

8. The apparatus according to claim 7, wherein the surface-sensation scanner comprises:
a sensor comprising at least one selected from a group consisting of a tactile sensor, an image sensor, a voice sensor, an olfactory sensor and a taste sensor; and
a surface-sensation analyzer for integrating and classifying sensations received by the sensor to analyze interaction among the sensations, thereby allowing sensing the surface of the object.

9. The apparatus according to claim 2, further comprising a surface-sensing information sharer for executing procedures necessary for sharing the reproduced surface-sensing information with a counterpart.
